(19) United States
(12) Patent Application Publication
(10) Pub. No.: US 2018/0313245 A1
(43) Pub. Date: Nov. 1, 2018

(54) EXHAUST GAS CONTROL APPARATUS FOR INTERNAL COMBUSTION ENGINE

(71) Applicant: TOYOTA JIDOSHA KABUSHIKI KAISHA, Toyota-shi (JP)

(72) Inventors: Nobusuke Kabashima, Gotenba-shi (JP); Toshihiro Mori, Gotenba-shi (JP)

(73) Assignee: TOYOTA JIDOSHA KABUSHIKI KAISHA, Toyota-shi (JP)

(21) Appl. No.: 15/963,509

(22) Filed: Apr. 26, 2018

(30) Foreign Application Priority Data
Apr. 28, 2017 (JP) 2017-090323

(51) Int. Cl. F01N 3/20; F02D 41/02; F02D 41/40; F01N 3/08

(52) U.S. Cl. CPC F01N 3/206; F02D 41/027; F02D 41/405; F01N 2570/14; F01N 3/0871; F01N 2610/03; F01N 2610/05; F01N 3/0814

(57) ABSTRACT

An exhaust gas control apparatus includes a NOₓ storage-reduction catalyst, and an injector capable of supplying a reducing agent containing hydrocarbon and carbon monoxide to the NOₓ storage-reduction catalyst and adjusting a CO ratio that is a ratio of carbon monoxide to hydrocarbon supplied to the NOₓ storage-reduction catalyst. The exhaust gas control apparatus controls the injector such that the CO ratio becomes lower when the NOₓ removal treatment is started than when the NOₓ removal treatment is ended.

### INCORPORATION BY REFERENCE

The disclosure of Japanese Patent Application No. 2017-090323 filed on Apr. 28, 2017 including the specification, drawings and abstract is incorporated herein by reference in its entirety.

### BACKGROUND

### 1. Technical Field

The present disclosure relates to an exhaust gas control apparatus for an internal combustion engine.

### 2. Description of Related Art

There are known exhaust gas control apparatuses that execute the processing (NOₓ removal treatment) of removing NOₓ stored in a NOₓ storage-reduction catalyst by supplying hydrocarbon (HC) and a reducing component (CO) having a higher reactivity of an oxidation-reduction reaction than that of HC to the NOₓ storage-reduction catalyst. For example, Japanese Unexamined Patent Application Publication No. 2010-19171 (JP 2010-19171 A) shows that, when the temperature of the NOₓ storage-reduction catalyst is lower than a reference temperature, the reactivity of HC is determined to decline and the supply concentration of CO is made higher.

As described above, since CO has a higher reactivity with NOₓ than HC, the supply concentration of CO may be further raised when the released amount of NOₓ from the NOₓ storage-reduction catalyst is constant. Meanwhile, the released amount of NOₓ from the NOₓ storage-reduction catalyst increases as the supply concentration of CO is higher. For the above-described reason, when the supply concentration of CO becomes high, the released amount of NOₓ may become excessive with respect to the amount of the reducing agent (HC and CO), and removal of NOₓ may become difficult. For the above-described reason, it is difficult to appropriately remove NOₓ.

### SUMMARY

The disclosure provides an apparatus device that appropriately removes NOₓ in a NOₓ storage-reduction catalyst.

An aspect of the disclosure relates to an exhaust gas control apparatus for an internal combustion engine. The exhaust gas control apparatus includes a NOₓ storage-reduction catalyst; a reducing agent supplying-and-adjusting device configured to supply a reducing agent containing hydrocarbon and carbon monoxide to the NOₓ storage-reduction catalyst and adjust a CO ratio that is a ratio of the carbon monoxide to the hydrocarbon supplied to the NOₓ storage-reduction catalyst; and an electronic control unit configured to control the reducing agent supplying-and-adjusting device. When a predetermined removal treatment execution condition is satisfied, the electronic control unit is configured to control the reducing agent supplying-and-adjusting device to supply the reducing agent to the NOₓ storage-reduction catalyst and to perform NOₓ removal treatment in which NOₓ stored in the NOₓ storage-reduction catalyst is removed. The electronic control unit is configured to control the reducing agent supplying-and-adjusting device, during the NOₓ removal treatment, such that the CO ratio becomes lower when the NOₓ removal treatment is started than when the NOₓ removal treatment is ended.

According to the aspect of the disclosure, the exhaust gas control apparatus can appropriately remove NOₓ in the NOₓ storage-reduction catalyst.

In the exhaust gas control apparatus according to the aspect of the disclosure, the reducing agent supplying-and-adjusting device may include an injector that injects fuel into a combustion chamber of the internal combustion engine. During the NOₓ removal treatment, the injector may be configured to perform, during one cycle of the internal combustion engine, multi-stage fuel injection including a first injection of injecting a first amount of fuel, and a second injection of injecting a second amount of fuel which is smaller than the first amount of fuel in the first injection after the first injection to supply the reducing agent to the NOₓ storage-reduction catalyst. The electronic control unit may be configured to control the injector, during the NOₓ removal treatment, such that a fuel injection timing of the second injection is later when the NOₓ removal treatment is started than when the NOₓ removal treatment is ended.

In the exhaust gas control apparatus according to the aspect of the disclosure, the electronic control unit may be configured to control the injector, during the NOₓ removal treatment, such that the fuel injection timing of the second injection is continuously or stepwise delayed according to an elapsed time after the NOₓ removal treatment is started.

In the exhaust gas control apparatus according to the aspect of the disclosure, the reducing agent supplying-and-adjusting device may include an injector that injects fuel into a combustion chamber of the internal combustion engine, and an exhaust gas recirculation device that supplies a portion of exhaust gas to the combustion chamber. During the NOₓ removal treatment, the injector may be configured to perform, during one cycle of the internal combustion engine, multi-stage fuel injection including a first injection of injecting a first amount of fuel, and a second injection of injecting a second amount of fuel which is smaller than the first amount of fuel in the first injection after the first injection to supply the reducing agent to the NOₓ storage-reduction catalyst. The electronic control unit may be configured to control the exhaust gas recirculation device such that an exhaust gas circulation rate, which is a ratio of an amount of the exhaust gas supplied to the combustion chamber to an amount of an intake gas supplied to the combustion chamber, becomes lower when the NOₓ removal treatment is started than when the NOₓ removal treatment is ended, during the NOₓ removal treatment.

In the exhaust gas control apparatus according to the aspect of the disclosure, the electronic control unit may be configured to adjust the CO ratio, during the NOₓ removal treatment, such that the CO ratio increases as time elapses after the NOₓ removal treatment is started.

In the exhaust gas control apparatus according to the aspect of the disclosure, the electronic control unit may be configured to adjust the exhaust gas recirculation device, during the NOₓ removal treatment, such that a total amount of hydrocarbon and carbon monoxide increases as time elapses after the NOₓ removal treatment is started.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic view of an exhaust gas control apparatus in a first embodiment;

FIG. 2A is a front view of a NOₓ storage-reduction catalyst as viewed from an exhaust gas inflow end;

FIG. 2B is a side sectional view of the NOₓ storage-reduction catalyst as cut in an exhaust gas flow direction;

FIG. 3 diagrammatically illustrates a substrate forming partition walls of the NOₓ storage-reduction catalyst, and a catalyst layer formed on a surface of the substrate;

FIG. 4 diagrammatically illustrates a NOₓ removal action in a case where an air-fuel ratio of exhaust gas is rich;

FIG. 5 is a timing chart of NOₓ storage amount and an air-fuel ratio (A/F);

FIG. 6A is a graph illustrating fuel injection timing in NOₓ removal treatment;

FIG. 6B is a graph illustrating a relationship between the fuel injection timing of after-injection and a CO ratio;

FIG. 7 is a timing chart of the fuel injection timing of the after-injection, the CO ratio, and NOₓ leak amount regarding a first test;

FIG. 8 is a timing chart of the fuel injection timing of the after-injection, the CO ratio, and the NOₓ leak amount regarding a second test;

FIG. 9A is a view diagrammatically illustrating a release action and a reduction action of NOₓ in an initial stage of the NOₓ removal treatment regarding the first test;

FIG. 9B is a view diagrammatically illustrating a release action and a reduction action of NOₓ in a later stage of the NOₓ removal treatment regarding the first test;

FIG. 10 is a view diagrammatically illustrating a release action and a reduction action of NOₓ regarding the first test;

FIG. 11A is a graph illustrating a relationship between the CO ratio, and the amount of NOₓ leaked from the NOₓ storage-reduction catalyst within 3 seconds after the NOₓ removal treatment is started;

FIG. 11B is a graph illustrating a relationship between the CO ratio, and the amount of NOₓ leaked from the NOₓ storage-reduction catalyst within 3 seconds before the NOₓ removal treatment is ended;

FIG. 12 is a timing chart of the fuel injection timing of the after-injection, the CO ratio, and the NOₓ leak amount regarding a third test;

FIG. 13A is a view diagrammatically illustrating a release action and a reduction action of NOₓ in the initial stage of the NOₓ removal treatment regarding the third test;

FIG. 13B is a view diagrammatically illustrating a release action and a reduction action of NOₓ in the later stage of the NOₓ removal treatment regarding the third test;

FIG. 14 is a graph illustrating a relationship between the time after the NOₓ removal treatment is started, and the CO ratio;

FIG. 15 is a flowchart illustrating a control routine of fuel injection control in the first embodiment;

FIG. 16 is a flowchart illustrating a fuel injection timing setting routine for setting the fuel injection timing of the after-injection in the first embodiment;

FIG. 17 is a schematic view of an exhaust gas control apparatus in a second embodiment;

FIG. 18 is a timing chart regarding a NOₓ removal treatment in the second embodiment;

FIG. 19 is a flowchart illustrating a control routine of fuel injection and EGR in the second embodiment; and

FIG. 20 is a flowchart illustrating an EGR setting routine for setting an EGR rate in the second embodiment.

### DETAILED DESCRIPTION OF EMBODIMENTS

Hereinafter, embodiments will be described in detail with reference to the drawings. In addition, in the following description, the same constituent elements will be designated by the same reference numerals.

### First Embodiment

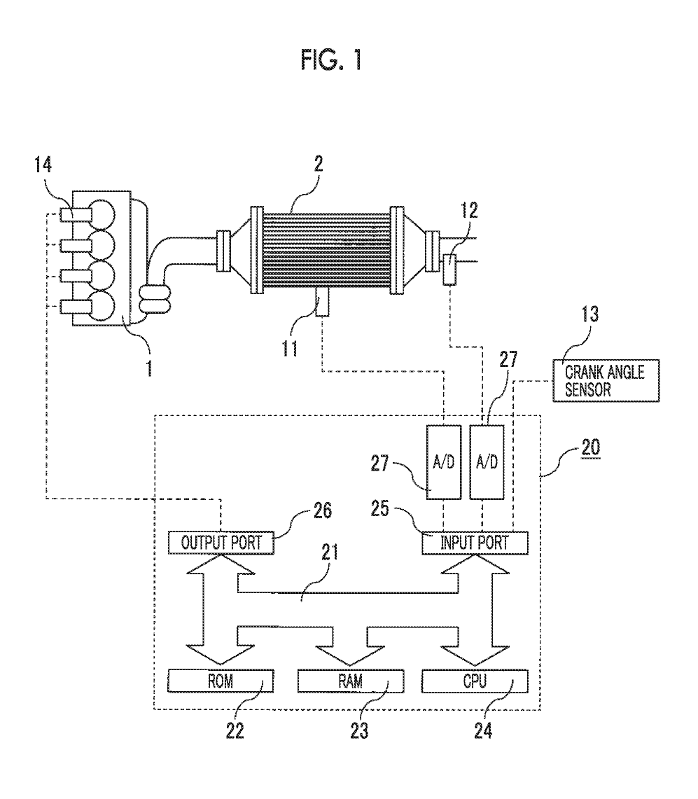

FIG. 1 illustrates a schematic view of an exhaust gas control apparatus in a first embodiment. The exhaust gas control apparatus for an internal combustion engine in the first embodiment includes an engine body 1, and a NOₓ storage-reduction catalyst 2 disposed within an exhaust passage downstream of the engine body 1 in an exhaust gas flow direction. Moreover, the exhaust gas control apparatus of the first embodiment includes a temperature sensor 11 disposed at the NOₓ storage-reduction catalyst 2, and a NOₓ sensor 12 disposed in the exhaust passage downstream of the NOₓ storage-reduction catalyst 2.

The engine body 1 combusts fuel in a combustion chamber formed inside the engine body 1, thereby generating a driving force. In the first embodiment, the engine body 1 is a diesel engine. That is, fuel is ignited by compressing the fuel after the fuel is injected from an injector 14 provided within the combustion chamber. NOₓ is contained in exhaust gas generated in the above-described case.

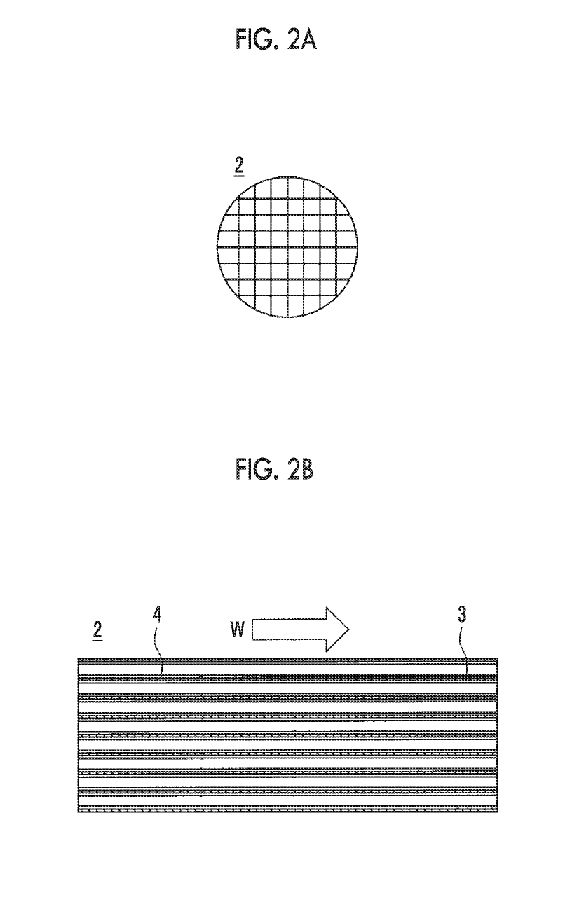

The NOₓ storage-reduction catalyst 2 controls the exhaust gas emitted from the engine body 1. The NOₓ storage-reduction catalyst 2 stores the NOₓ emitted from the engine body 1 when an air-fuel ratio of the exhaust gas is lean. The NOₓ storage-reduction catalyst 2 releases, reduces, and removes the stored NOₓ when the air-fuel ratio of the exhaust gas is rich. The temperature sensor 11 disposed at the NOₓ storage-reduction catalyst 2 measures the temperature of the NOₓ storage-reduction catalyst 2. The NOₓ sensor 12 disposed downstream of the NOₓ storage-reduction catalyst 2 in an exhaust gas flow direction measures the amount of NOₓ contained in the exhaust gas. The structure of the NOₓ storage-reduction catalyst 2 will be described below, referring to FIG. 2A and FIG. 2B.

A control unit 20 is constituted of a digital computer, and includes a ROM 22, a RAM 23, and a CPU 24 that are mutually connected by bidirectional buses 21, an input port 25, and an output port 26.

An analog signal from the temperature sensor 11 or the NOₓ sensor 12 is converted into a digital signal via a corresponding AD converter 27, and is input to the input port 25. Additionally, a digital signal output from a crank angle sensor 13 for detecting the rotational speed of a crankshaft is input to the input port 25. As described above, output signals of various sensors needed to control the internal combustion engine are input to the input port 25. The output port 26 is connected to the injector 14 or the like, and outputs a digital signal calculated by the CPU 24.

FIG. 2A is a front view of the NOₓ storage-reduction catalyst 2 as viewed from an exhaust gas inflow end. FIG. 2B is a side sectional view of the NOₓ storage-reduction catalyst 2 as cut in the exhaust gas flow direction. The NOₓ storage-reduction catalyst 2 has a uniform cross section over its entire length. A plurality of exhaust gas flow passages surrounded by partition walls is formed inside the NOₓ storage-reduction catalyst 2. The exhaust gas flow passages have a square section, and are formed so as to extend linearly while maintaining a constant width. A substrate 3 that forms the exhaust gas flow passages is made of a ceramic, and is formed of, for example, cordierite, mullite, or α-alumina. In the above-described case, the substrate 3 may be formed of, particularly, cordierite. A catalyst layer 4 containing a catalyst for controlling the exhaust gas is formed on a surface of each partition wall.

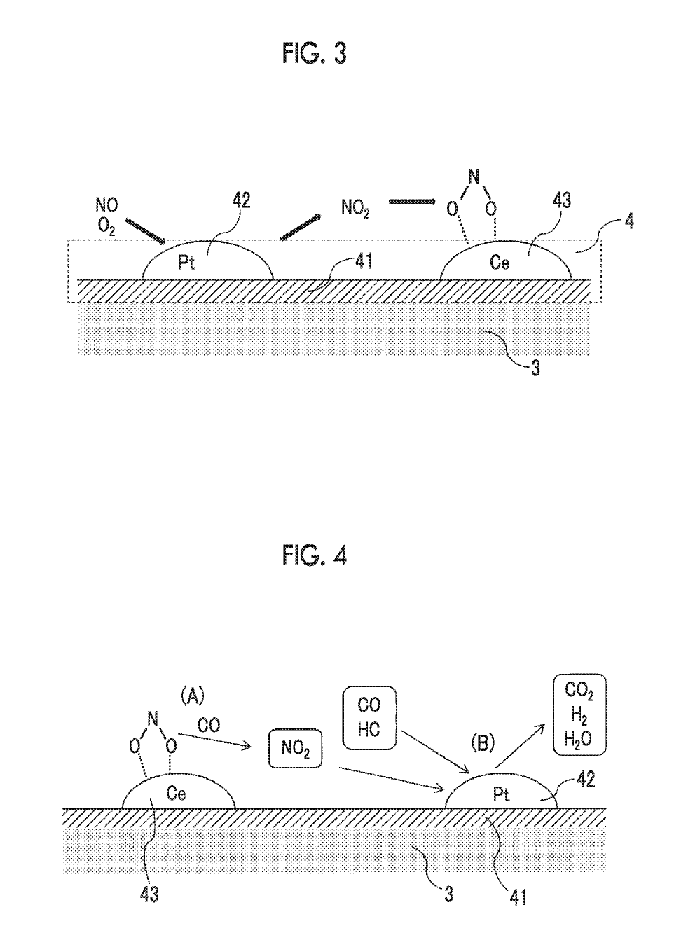

FIG. 3 diagrammatically illustrates the substrate 3 forming the partition walls of the NOₓ storage-reduction catalyst 2, and the catalyst layer 4 formed on a surface of the substrate 3. The catalyst layer 4 includes a carrier 41, and a noble metal 42 and a NOₓ storage material 43 that are carried on a surface of the carrier 41. Particularly in FIG. 3, the surface of a part of the carrier 41 included within the catalyst layer 4 is diagrammatically illustrated. As illustrated in FIG. 3, the noble metal 42, and the NOₓ storage material 43 for storing NOₓ are carried on the carrier 41 made of, for example, alumina (Al₂O₃).

The noble metal 42 has an action of promoting oxidization of HC or CO, and an action of promoting a reduction in NOₓ. The noble metal 42 is made of at least one noble metal among platinum (Pt), palladium (Pd), and rhodium (Rh). In the first embodiment, the noble metal 42 includes Pt, Pd, and Rh, respectively.

The NOₓ storage material 43 stores NOₓ in the exhaust gas. The NOₓ storage material 43 is an alkali metal or any one or both of an alkaline earth metal and a rare earth metal. For example, the alkali metal is potassium (K), rubidium (Rb), or cesium (Cs), the alkaline earth metal is calcium (Ca), strontium (Sr), or barium (Ba), and the rare earth metal is lanthanum (La), cerium (Ce), or praseodymium (Pr). In the first embodiment, the NOₓ storage material 43 is an oxide of Ce.

FIG. 3 diagrammatically illustrates a NOₓ storage action of the NOₓ storage-reduction catalyst 2 when the air-fuel ratio of the exhaust gas flowing into the NOₓ storage-reduction catalyst 2 is lean. NO contained in the exhaust gas is oxidized by the noble metal 42 to turn into NO₂. The oxidized NO₂ or NO₂ contained in the exhaust gas emitted from the engine body is stored by the NOₓ storage material 43.

Two actions of “adsorption” and “absorption” are included in the “storage” of NOₓ. The “adsorption” means that NOₓ is held on the surface of the NOₓ storage material 43 due to an intermolecular force weaker than ionic bonding, such as Van der Waals forces. Meanwhile, the “absorption” means that NO₂ is further oxidized to turn into a nitrate ion (NO₃⁻), and is held in the form of nitrate in the NOₓ storage material 43.

FIG. 4 diagrammatically illustrates a NOₓ removal action in a case where the air-fuel ratio of the exhaust gas is rich. The NOₓ removal action is divided roughly into two actions in the first embodiment. The first action is an action ((A) in FIG. 4) of releasing NOₓ stored in the NOₓ storage material 43 into the exhaust gas, and the second action is an action ((B) in FIG. 4) of reducing NOₓ released into the exhaust gas. In the following, the respective actions will be described in order.

The release (action (A)) of NOₓ stored in the NOₓ storage material 43 into the exhaust gas is caused in a case where the air-fuel ratio of the exhaust gas is rich, that is, in a case where the exhaust gas is in a reduction atmosphere. For example, the NOₓ adsorbed on the surface of the NOₓ storage material 43 is released toward the exhaust gas when the exhaust gas is in the reduction atmosphere. Meanwhile, the NOₓ absorbed in the NOₓ storage material 43 is reduced from nitrate ion NO₃⁻, is returned to NO₂ again, and is released into the exhaust gas when the exhaust gas is in the reduction atmosphere. The released amount of NOₓ as described above increases as the amount of NOₓ stored in the NOₓ storage material 43 is larger.

The reduction (action (B)) of NOₓ released into the exhaust gas is performed via a noble metal catalyst by HC or CO that is a reducing agent in the exhaust gas. More NOₓ can be reduced as the supply amount of the reducing agent is larger. Since the reduction action of CO is stronger than that of HC, more NOₓ can be reduced as the molar ratio of CO to HC (hereinafter referred to as a “the CO ratio”) in the reducing agent is higher than HC in a case where the same amount of reducing agent is supplied to the NOₓ storage-reduction catalyst 2.

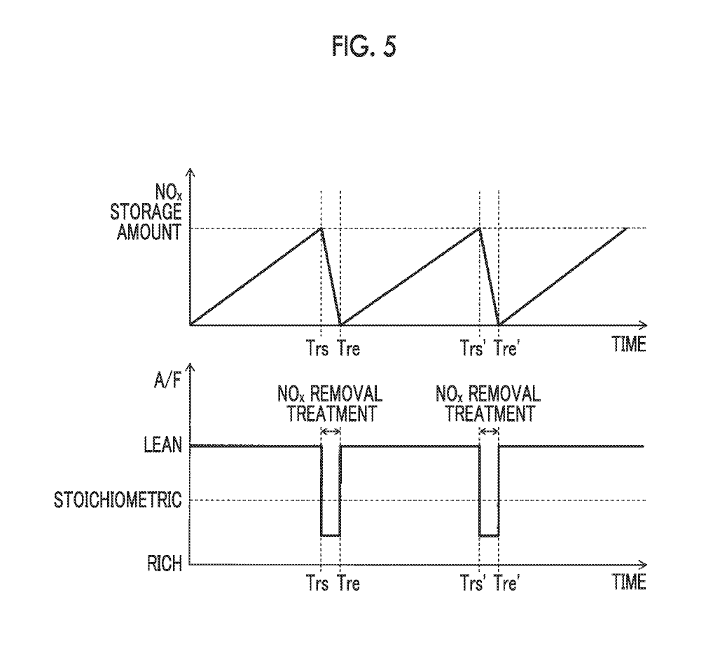

FIG. 5 is a timing chart of the NOₓ storage amount and the air-fuel ratio (A/F). In the illustrated example, the internal combustion engine normally operates in a period before time Trs. In the first embodiment, the diesel engine is used as the internal combustion engine. Therefore, during a normal operation, the air-fuel ratio of the exhaust gas is a lean air-fuel ratio with excessive oxygen, and NOₓ is emitted from the engine body in the above-described case. NOₓ emitted from the engine body flows into the NOₓ storage-reduction catalyst 2, and is stored in the NOₓ storage-reduction catalyst 2. As described above, the concentration of NOₓ in the exhaust gas emitted from the NOₓ storage-reduction catalyst 2 is decreased. Hence, in the period before time Trs, the NOₓ storage amount of the NOₓ storage-reduction catalyst 2 increases gradually. Then, when the NOₓ storage amount increases gradually, a predetermined reference value is exceeded at time Trs. In the first embodiment, when the predetermined reference value is exceeded, the NOₓ removal treatment is started.

In the NOₓ removal treatment, the reducing agent containing HC and CO is supplied to the NOₓ storage-reduction catalyst as will be described below. When the NOₓ removal treatment is started at time Trs, the air-fuel ratio of the exhaust gas flowing into the NOₓ storage-reduction catalyst 2 becomes a rich air-fuel ratio with an excessive reducing agent. When the exhaust gas of the rich air-fuel ratio flows into the NOₓ storage-reduction catalyst 2 as described above, as illustrated in FIG. 4, NOₓ stored in the NOₓ storage-reduction catalyst 2 is released, and is reduced by the reducing agent. Hence, when the NOₓ removal treatment is continued after time Trs, the NOₓ storage amount decreases gradually with an increase in the elapsed time of the NOₓ removal treatment. In the first embodiment, the NOₓ removal treatment is ended at time Tre when the NOₓ storage amount of the NOₓ storage-reduction catalyst 2 reaches substantially zero, the normal operation is started again, and the same processing is repeated after that.

In the first embodiment, when the NOₓ storage amount reaches substantially zero, the NOₓ removal treatment is ended. However, as long as the NOₓ storage amount has a value between the above-described reference value and zero, the NOₓ storage amount does not need to be substantially zero. In the first embodiment, the NOₓ storage amount is estimated and when the estimated NOₓ storage amount reaches substantially zero, the NOₓ removal treatment is ended. However, the NOₓ removal treatment may be ended when a given time period (the time period until the NOₓ storage amount reaches zero or a time shorter than a time period until the NOₓ storage amount reaches zero) has elapsed after the NOₓ removal treatment is started.

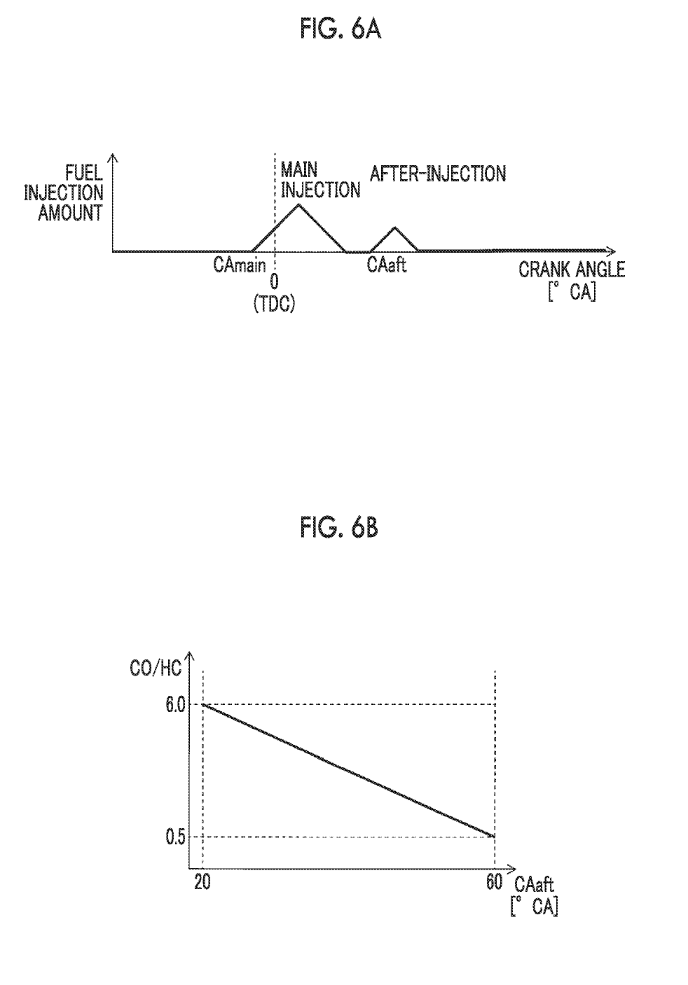

A method of supplying the reducing agent to the NOₓ storage-reduction catalyst 2 during the NOₓ removal treatment will be described. FIG. 6A is a view illustrating the fuel injection timing in the NOₓ removal treatment in the first embodiment, and illustrates a relationship between a crank angle around a compression top dead center (TDC) and the amount of fuel injected from the injector 14.

As illustrated in FIG. 6A, in the first embodiment, at least a main injection and an after-injection are performed by injecting fuel into the combustion chamber from the injector 14. The main injection is performed around the compression TDC (in the illustrated example, start of injection at time CAmain), and the largest amount of fuel is injected during 1 cycle. Meanwhile, the after-injection is performed at a predetermined timing (in the illustrated example, start of injection at time CAaft) after the end of the main injection, and less fuel is injected than in main injection. Most of the fuel injected by the main injection is combusted within the combustion chamber, and mainly contributes to the output of the internal combustion engine. In contrast to the above, some or all of the after-injected fuel flows out of the engine body 1 without being combusted in the combustion chamber. Hence, some or all of the after-injection fuel flows into the NOₓ storage-reduction catalyst 2. For the above-described reason, in the first embodiment, the reducing agent, such as HC and CO, is supplied to the NOₓ storage-reduction catalyst 2 by performing the after-injection during the NOₓ removal treatment.

In a case where the reducing agent is supplied by performing the after-injection, the CO ratio in the reducing agent varies depending on the fuel injection timing of the after-injection. FIG. 6B is a graph illustrating a relationship between the fuel injection timing CAaft of the after-injection and the CO ratio. As can be seen from FIG. 6B, while the fuel injection timing CAaft of the after-injection is from 20° after top dead center (ATDC) and 60° ATDC, the CO ratio declines as the fuel injection timing CAaft of the after-injection is delayed. The reasons are inferred as follows. That is, since the fuel injection timing of the main injection and the fuel injection timing of the after-injection become relatively close to each other when the fuel injection timing of the after-injection is early (20° ATDC), spray in the after-injection interferes with a space where spray in the main injection remains. For the above-described reason, since a local fuel concentration increases and incomplete combustion is more likely to occur, the CO ratio increases. Meanwhile, since the fuel injection timing of the main injection and the fuel injection timing of the after-injection are relatively separated from each other when the after-injection is delayed (60° ATDC), any interference between the spray in the main injection and the spray in the after-injection is further suppressed. Since the incomplete combustion is suppressed for the above-described reason, the CO ratio declines. As described above, the CO ratio is controlled by changing the fuel injection timing CAaft of the after-injection.

During the NOₓ removal treatment, the amount of NOₓ flowing out of the NOₓ storage-reduction catalyst 2 (hereinafter referred to as “NOₓ leak amount”) varies depending on the CO ratio in the reducing agent flowing into the NOₓ storage-reduction catalyst. In the following, a relationship between the CO ratio and the NOₓ leak amount during the NOₓ removal treatment will be described.

In order to investigate the relationship between the CO ratio in the reducing agent flowing into the NOₓ storage-reduction catalyst 2 and the NOₓ leak amount, the CO ratio of the reducing agent flowing into the NOₓ storage-reduction catalyst 2 was changed, and the leak amount of NOₓ from the NOₓ storage-reduction catalyst 2 was evaluated.

In order to evaluate the removal amount of NOₓ, first, Pt, Pd, and Rh were used as the noble metal 42, and the NOₓ storage-reduction catalyst 2 using a Ce oxide as the NOₓ storage material 43 was prepared. Next, the NOₓ storage-reduction catalyst 2 was heated for 42 hours at 750° C. Next, the heated NOₓ storage-reduction catalyst 2 was disposed on the exhaust gas downstream side of the diesel engine, the diesel engine was operated in the above-described state, and NOₓ was made to be stored in the NOₓ storage-reduction catalyst 2. In order to store NOₓ in the NOₓ storage-reduction catalyst, the NOₓ storage-reduction catalyst 2 was maintained for 5 minutes in a 200° C. state.

Subsequently, the NOₓ removal treatment was executed by the after-injection by maintaining the air-fuel ratio of the exhaust gas at 13.5 for 10 seconds. During the NOₓ removal treatment, the leak amount of NOₓ from the NOₓ storage-reduction catalyst 2 was measured by the NOₓ sensor 12 disposed at a downstream end of the NOₓ storage-reduction catalyst 2. In measuring the NOₓ leak amount, the CO ratio flowing into the NOₓ storage-reduction catalyst 2 was changed, and two tests, a first test and a second test were performed.

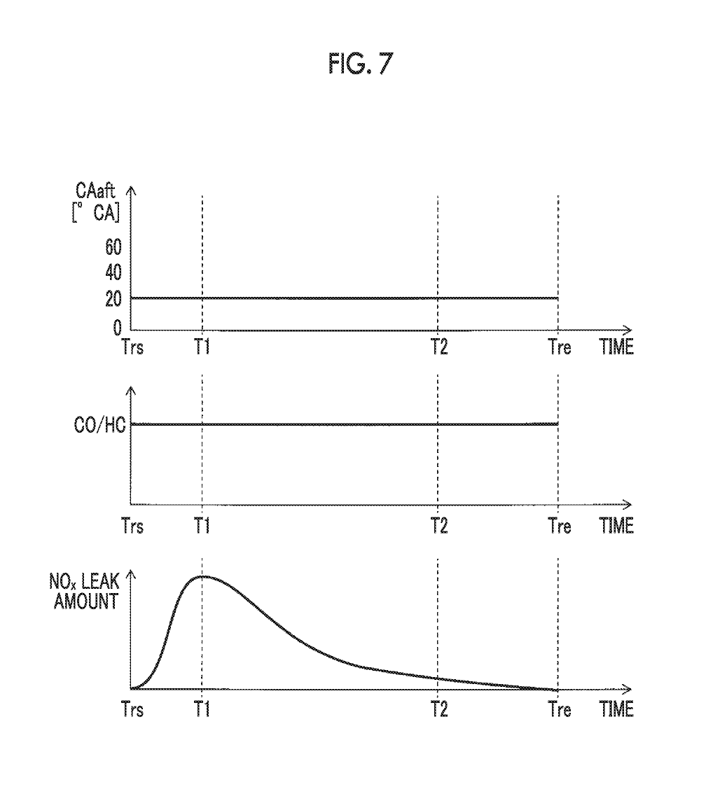

FIG. 7 is a timing chart of the fuel injection timing CAaft of the after-injection, the CO ratio, and the NOₓ leak amount regarding the first test. A horizontal axis represents time and represents a period of time from start time Trs of the NOₓ removal treatment to end time Tre of the NOₓ removal treatment.

In the first test, the fuel injection timing CAaft of the after-injection was maintained at 20° ATDC in an entire period of time from start time Trs of the NOₓ removal treatment to end time Tre of the NOₓ removal treatment. As a result of the above, in the first test, the CO ratio flowing into the NOₓ storage-reduction catalyst 2 was kept relatively high over the entire range during the execution of the NOₓ removal treatment.

As can be seen from FIG. 7, the NOₓ leak amount increases from start time Trs of the NOₓ removal treatment to time T1, and decreases from time T1 to end time Tre of the NOₓ removal treatment. As described above, when the CO ratio in the reducing agent was made higher, more leak of NOₓ was observed in an initial stage of the NOₓ removal treatment (around time T1).

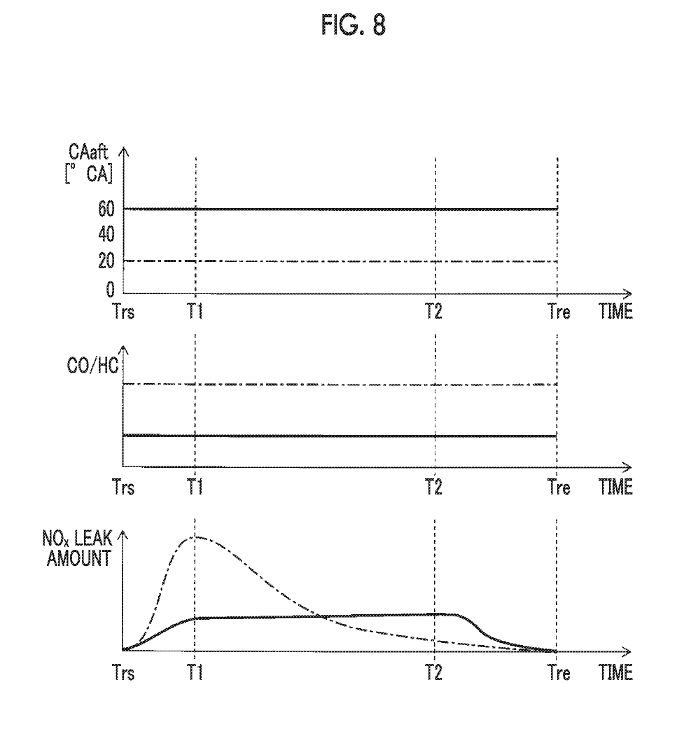

FIG. 8 is a timing chart of the fuel injection timing CAaft of the after-injection, the CO ratio, and the NOₓ leak amount regarding the second test. Solid lines in the drawing represent the transition of the fuel injection timing CAaft of the after-injection, and the like, in the second test and dotted lines represent the transition of the fuel injection timing CAaft of the after-injection, and the like, in the first test.

In the second test, the fuel injection timing CAaft of the after-injection was maintained at 60° ATDC over the entire range during the execution of the NOₓ removal treatment. As a result of the above, in the second test, the CO ratio flowing into the NOₓ storage-reduction catalyst was kept relatively low over the entire range during the execution of the NOₓ removal treatment.

As can be seen from FIG. 8, the NOₓ leak amount increases from start time Trs of the NOₓ removal treatment to time T1, and remains substantially constant from time T1 to time T2. As described above, in the second test, leak of NOₓ was further suppressed in the initial stage of the NOₓ removal treatment as compared to the first test. However, the leak amount of NOₓ could not be decreased in a later stage of the NOₓ removal treatment.

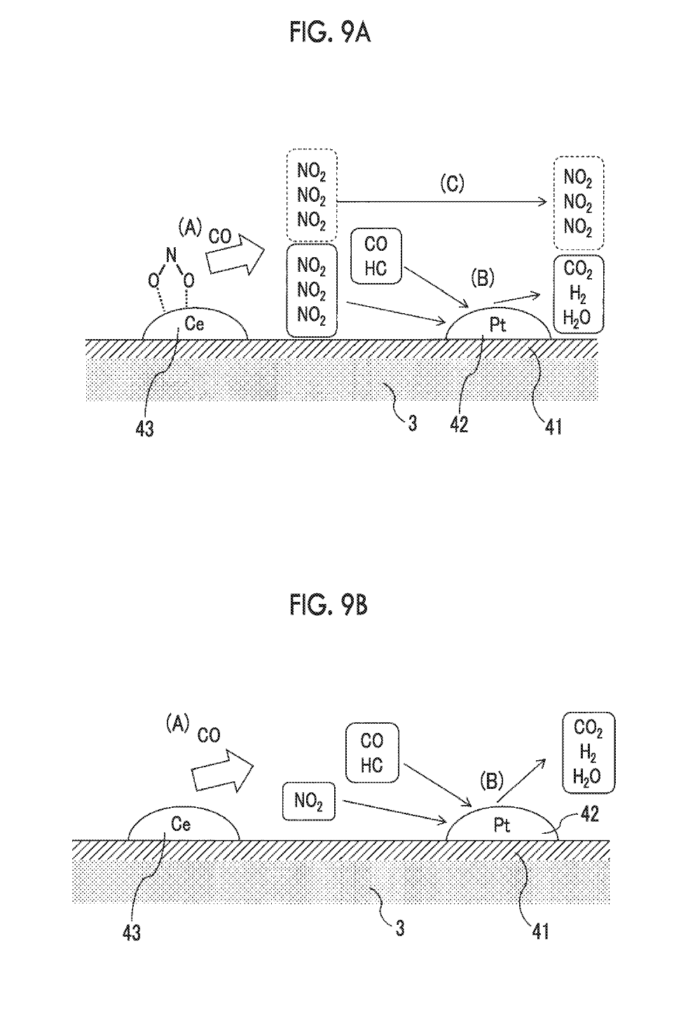

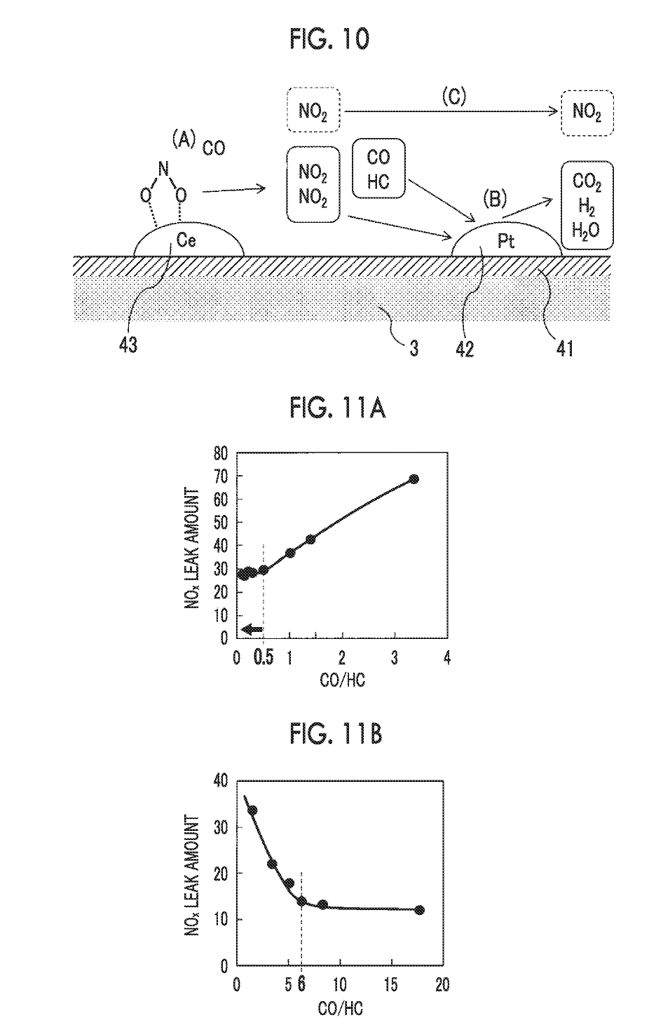

As described above, the reactivity of CO with NOₓ is higher than that of HC with NOₓ. However, irrespective of the CO ratio being relatively high, the NOₓ leak amount in the first test is larger than that in the second test in the initial stage of the NOₓ removal treatment. From the above-described result, when the CO ratio is relatively high, the amount of NOₓ released from the NOₓ storage-reduction catalyst is considered to be larger. In the following, the reason why the NOₓ leak amount differs between the first test and the second test, that is, the reason why the transition of the NOₓ leak amount varies depending on the CO ratio in the reducing agent flowing into the NOₓ storage-reduction catalyst 2 will be described with reference to FIGS. 9A, 9B, and 10 based on the above-described consideration.

FIG. 9A is a view diagrammatically illustrating a release action and a reduction action of NOₓ at time T1 when the first test is performed. As described above, it is considered that, as the CO ratio is higher, the action (arrow (A) of FIG. 9A) of releasing NOₓ stored in the NOₓ storage material 43 into the exhaust gas becomes stronger. Additionally, in the initial stage of the NOₓ removal treatment, the amount of NOₓ stored in the NOₓ storage material is relatively large. Hence, at time T1 of the first test, the CO ratio is relatively high and the NOₓ storage amount is also relatively large. Therefore, a relatively large amount of NOₓ is released into the exhaust gas from the NOₓ storage material 43.

Subsequently, as in arrow (B) of FIG. 9A, NOₓ released into the exhaust gas reacts with HC and CO by the noble metal 42, and is reduced into N₂ and removed. In the first test, since a relatively large amount of NOₓ with respect to the amount of the supplied reducing agent HC and CO is released into the exhaust gas, a portion of NOₓ flows (leaks) out of the NOₓ storage-reduction catalyst 2 without being removed (arrow (C) of FIG. 9A). For the above reason, it is inferred that the leak amount of NOₓ becomes relatively large in time T1 of FIG. 8.

FIG. 9B is a view diagrammatically illustrating a release action and a reduction action of NOₓ at time T2 when the first test is performed. At time T2, the amount of NOₓ stored in the NOₓ storage material 43 is relatively small. For this reason, even when the CO ratio of the reducing agent is relatively high, the amount of NOₓ released into the exhaust gas from the NOₓ storage material 43 is relatively small (arrow (A)). For the above-described reason, it is inferred that, due to HC and CO (arrow (B)), more NOₓ in the exhaust gas is reduced and the leak amount of NOₓ decreases further.

As described above, in a case where the CO ratio in the reducing agent flowing into the NOₓ storage-reduction catalyst 2 is relatively high, the amount of NOₓ released into the exhaust gas becomes excessive in the initial stage of the NOₓ removal treatment (around time T1), it is inferred that a portion of NOₓ leaks from the NOₓ storage-reduction catalyst 2.

FIG. 10 is a view diagrammatically illustrating a release action and a reduction action of NOₓ in a period from time T1 to time T2 when the second test is performed. Although the amount of NOₓ stored in the NOₓ storage material 43 is relatively large, the CO ratio in the reducing agent is relatively low. Hence, even in the initial stage of the NOₓ removal treatment, the amount of NOₓ released from the NOₓ storage material 43 is small compared to the first test (arrow (A) of FIG. 10). Subsequently, NOₓ released into the exhaust gas is made to react with HC and CO by the noble metal 42, and is reduced into N₂ and removed (arrow (B) of FIG. 10). However, in the second test, the CO ratio is relatively low, and therefore, the concentration of CO having a higher reactivity than HC is low. For the above-described reason, it is inferred that a portion of NO flows (leaks) out of the NOₓ storage-reduction catalyst 2 without being decreased by the reducing agent (arrow (C) of FIG. 10).

As described above, in a case where the CO ratio in the reducing agent flowing into the NOₓ storage-reduction catalyst 2 is relatively low, the CO ratio is relatively low during the NOₓ removal treatment (around the period from time T1 to time T2). Therefore, it is inferred that the NOₓ reduction efficiency is relatively low and a portion of NOₓ leaks from the NOₓ storage-reduction catalyst 2.

A relationship between the NOₓ leak amount immediately after the NOₓ removal treatment is started and the CO ratio was measured. FIG. 11A is a graph illustrating a relationship between the CO ratio, and the amount of NOₓ leaked from the NOₓ storage-reduction catalyst 2 in 3 seconds after the NOₓ removal treatment is started. As can be clear from FIG. 11A, the NOₓ leak amount increases as the CO ratio is high. As described in with reference to FIG. 9A, the above is inferred to be because, when the CO ratio is relatively high in the initial stage of the NOₓ removal treatment, there is a case where the leak amount of NOₓ increases and NOₓ cannot be sufficiently decreased by the reducing agent. As can be seen from FIG. 11A, when the CO ratio becomes equal to or smaller than a certain value (in the illustrated example, 0.5), the NOₓ leak amount hardly varies. For the above-described reason, in the initial stage of the NOₓ removal treatment, the fuel injection timing of the after-injection, and the like may be controlled such that the CO ratio becomes equal to or smaller than the certain value (in the illustrated example, equal to or smaller than 0.5).

Subsequently, a relationship between the NOₓ leak amount immediately before the NOₓ removal treatment is ended and the CO ratio was measured. FIG. 11B is a graph illustrating a relationship between the CO ratio, and the amount of NOₓ leaked from the NOₓ storage-reduction catalyst 2 in 3 seconds immediately before the NOₓ removal treatment is ended. As can be clear from FIG. 11B, the NOₓ leak amount increases as the CO ratio declines. As described with reference to FIG. 10, the reason is inferred to be because the NOₓ reduction efficiency becomes low when the CO ratio is relatively low. As can be seen from FIG. 11B, when the CO ratio becomes greater than a certain value (in the illustrated example, 6), the NOₓ leak amount hardly varies. For the above-described reason, the fuel injection timing of the after-injection, and the like may be controlled such that the CO ratio becomes equal to or greater the certain value (in the illustrated example, 6) immediately before the NOₓ removal treatment is ended.

As described above, in the first test, in a case where the CO ratio in the reducing agent is relatively high, NOₓ leaks immediately after the NOₓ removal treatment is started. Meanwhile, in the second test, in a case where the CO ratio in the reducing agent is relatively low, NOₓ leaks during the later stage of the NOₓ removal treatment. As described above, when the fuel injection timing of the after-injection is made constant, there is a problem that it is difficult to maintain a small NOₓ leak amount in the entire period during the execution of the NOₓ removal treatment.

Thus, a third test was executed in which, in the initial stage of the NOₓ removal treatment, the fuel injection timing CAaft of the after-injection was set to a retarded side and the CO ratio in the exhaust gas was made relatively low, and in the later stage of the NOₓ removal treatment, the fuel injection timing CAaft of the after-injection was set to an advanced side and the CO ratio in the exhaust gas was made relatively high. Particularly, in the third test, the fuel injection timing CAaft of the after-injection was gradually advanced from 60° ATDC to 20° ATDC with the elapsed time from the start of the NOₓ removal treatment. Test conditions other than the fuel injection timing CAaft of the after-injection were the same as those of the first test.

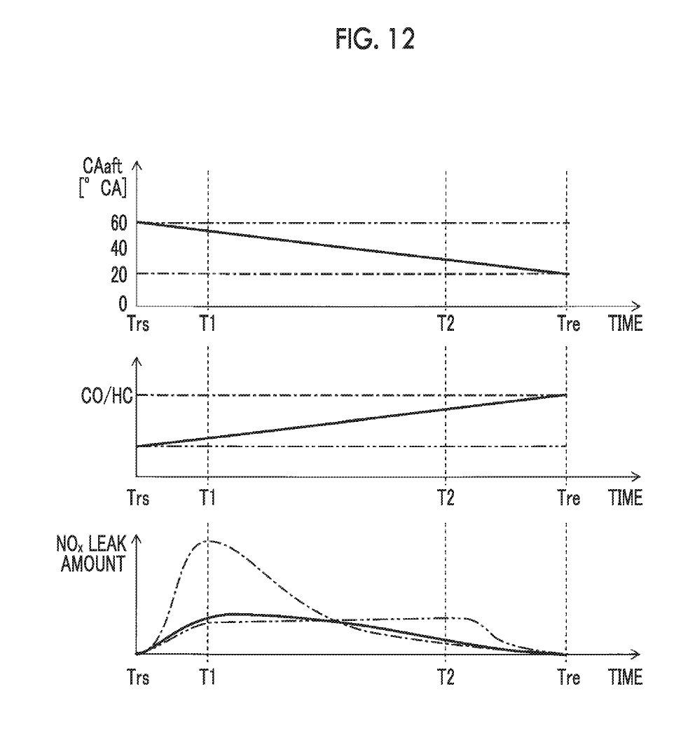

Solid lines of FIG. 12 represent the transition of the fuel injection timing CAaft of the after-injection, the CO ratio, and the NOₓ leak amount in the third test. A horizontal axis represents time and represents a period of time from start time Trs of the NOₓ removal treatment to end time Tre of the NOₓ removal treatment. Dotted lines of FIG. 12 represent the transition of the fuel injection timing CAaft of the after-injection, and the like, in a case where the fuel injection timing CAaft of the after-injection is fixed to 20° ATDC (first test), and two-dot chain lines of FIG. 12 represent the transition of the fuel injection timing CAaft of the after-injection, and the like, in a case where the fuel injection timing CAaft of the after-injection is fixed to 60° ATDC (second test). Hence, the dotted lines and the two-dot chain lines of FIG. 12 respectively represent the same transitions as the solid lines of FIG. 7 and the solid lines of FIG. 8.

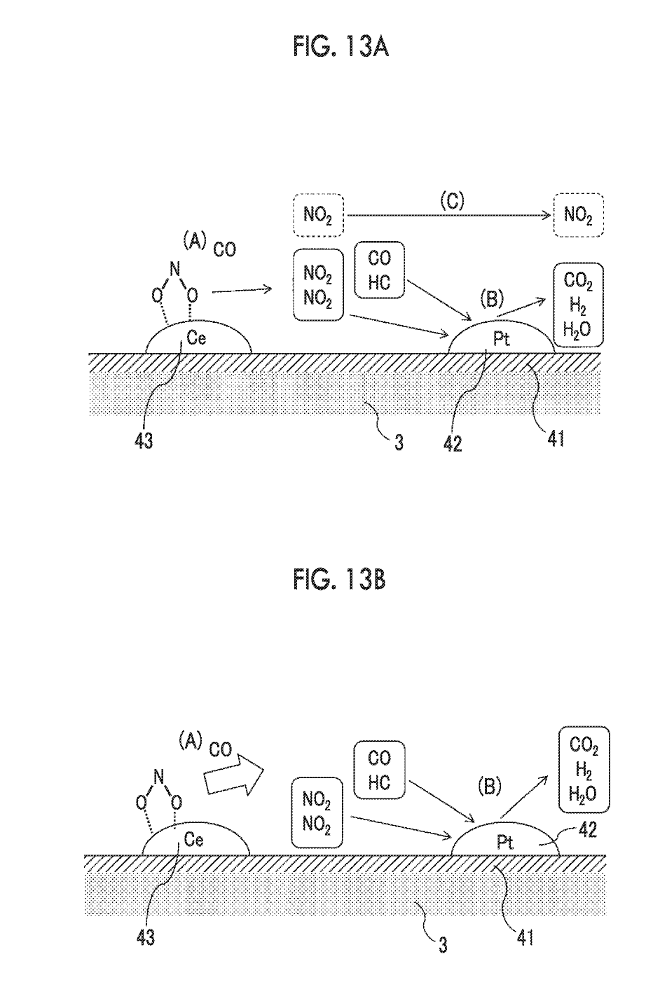

In the third test, the CO ratio was made low with the elapsed time from the start of the NOₓ removal treatment such that the CO ratio becomes lower in the initial stage of the NOₓ removal treatment and the CO ratio increases in the later stage. When the CO ratio was controlled as described above, the NOₓ leak amount could be further decreased as compared to the first test and the second test. That is, in the third test, the leak amount of NOₓ resulting from NOₓ being released in relatively large quantities from the NOₓ storage material 43 in the initial stage of the NOₓ removal treatment could be more appropriately suppressed. Moreover, the leak amount of NOₓ in the later stage of the NOₓ removal treatment could be further decreased. The reason why the above phenomenon occurs will be described referring to FIG. 13A and FIG. 13B.

FIG. 13A is a view diagrammatically illustrating a release action and a reduction action of NOₓ at time T1 (in the initial stage of the NOₓ removal treatment). In the first embodiment, the fuel injection timing CAaft of the after-injection is about 60° ATDC and the CO ratio is relatively low. Therefore, at time T1, the same action as the action illustrated in FIG. 10 occurs. Hence, as compared to the first test having a relatively high CO ratio, the NOₓ leak amount can be further decreased in the initial stage of the NOₓ removal treatment.

FIG. 13B is a view diagrammatically illustrating a release action and a reduction action of NOₓ at time T2 (the later stage of the NOₓ removal treatment). The CO ratio of the reducing agent supplied becomes high as compared to FIG. 10. For the above-described reason, the amount of NOₓ released from the NOₓ storage material 43 further increases. However, in the above-described case, the NOₓ storage amount of the NOₓ storage material 43 does not become exceedingly large. Therefore, the amount of NOₓ that is increased by making the CO ratio relatively high is not exceedingly large. Meanwhile, since the reduction efficiency of NOₓ increases when the CO ratio becomes relatively high, more NOₓ is removed. As a result of the above, as compared to the low second test of the CO ratio, the leak amount of NOₓ can be further decreased in the later stage of the NOₓ removal treatment.

Based on the results of the third tests and the above-described consideration, the fuel injection timing of the after-injection according to the first embodiment is controlled in the NOₓ removal treatment such that the CO ratio when the NOₓ removal treatment is started becomes lower than that when the NOₓ removal treatment is ended.

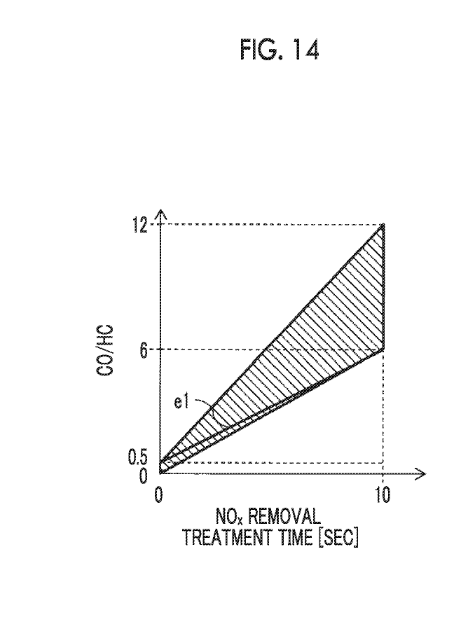

FIG. 14 is a graph illustrating a relationship between the time after the NOₓ removal treatment is started and the CO ratio. FIG. 14 illustrates an example in a case where the NOₓ removal treatment is performed for 10 seconds. Hence, 0 seconds of FIG. 14 indicates the start of the NOₓ removal treatment, and 10 seconds indicates the end of the NOₓ removal treatment. Additionally, in the first embodiment, the CO ratio during the NOₓ removal treatment is changed as illustrated by solid lines e1 in the drawing.

That is, in the first embodiment, at the time of the start of the NOₓ removal treatment, the fuel injection timing of the after-injection is controlled such that the CO ratio has a relatively low value (in the illustrated example, about 0.5). On the other hand, at the time of the end of the NOₓ removal treatment, the fuel injection timing of the after-injection is controlled such that the CO ratio has a relatively high value (in the illustrated example, about 6). In addition, in the first embodiment, the fuel injection timing of the after-injection is controlled such that the CO ratio increases as time elapses from the start of the NOₓ removal treatment. Particularly, in the first embodiment, the fuel injection timing of the after-injection is controlled such that the CO ratio increases in accordance with the elapsed time from the start of the NOₓ removal treatment.

As described with reference to FIG. 11A, in the initial stage of the NOₓ removal treatment, the NOₓ leak amount can be minimized when the CO ratio is equal to or smaller than 0.5. Hence, in the first embodiment, the fuel injection timing of the after-injection may be controlled such that the CO ratio becomes equal to or smaller than 0.5 at the time of the start of the NOₓ removal treatment. On the other hand, as described with reference to FIG. 11B, in the later stage of the NOₓ removal treatment, the NOₓ leak amount can be minimized as the CO ratio is equal to or greater than 6. Hence, in the first embodiment, the fuel injection timing of the after-injection may be controlled such that the CO ratio becomes equal to or greater than 6 at the time of the end of the NOₓ removal treatment. However, depending on the control of the fuel injection timing of the after-injection, the CO ratio cannot be made infinitely high, and has an upper limit (for example, 12). Therefore, in the first embodiment, the CO ratio may be equal to or greater than 6 and equal to or smaller than 12 at the time of the end of the NOₓ removal treatment. As described above, in the first embodiment, the CO ratio may transit within a hatched region in FIG. 14 in the NOₓ removal treatment.

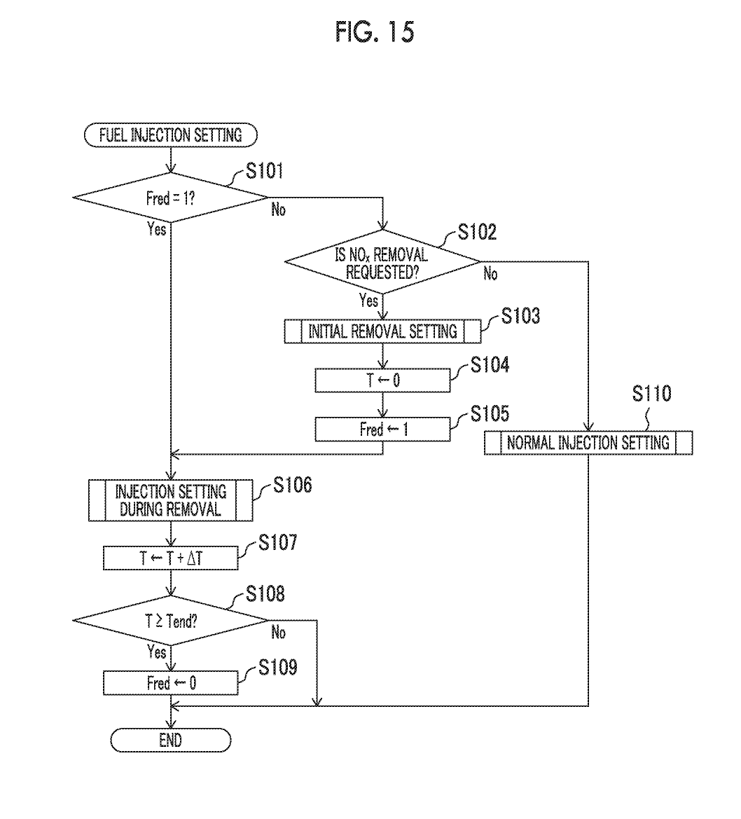

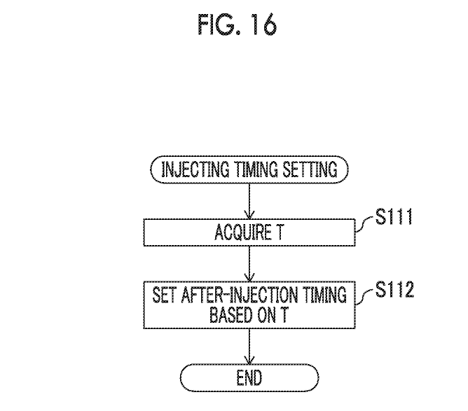

In the following, the control of the NOₓ removal treatment of the first embodiment will be described with reference to FIGS. 15 and 16. FIG. 15 is a flowchart illustrating a control routine of fuel injection setting control in the first embodiment. The control routine of FIG. 15 is executed when a crank angle CA measured by the crank angle sensor 13 becomes a predetermined crank angle CA.

In Step S101, the control unit 20 determines whether or not a removal treatment flag Fred is set. The removal treatment flag Fred is a flag that is reset while the NOₓ removal treatment is performed and is set when the NOₓ removal treatment ends. In a case where the removal treatment flag Fred is not set in Step S101, the main routine proceeds to Step S102 in order to set fuel injection for the NOₓ removal treatment. On the other hand, in a case where the removal treatment flag Fred is set in Step S101, the main routine proceeds to Step S106.

In Step S102, the control unit 20 determines whether or not an execution condition of the NOₓ removal treatment is satisfied. In the first embodiment, for example, when the NOₓ storage amount of the NOₓ storage-reduction catalyst 2 increases than a predetermined NOₓ storage amount, the execution condition of the NOₓ removal treatment is satisfied. In Step S102, in a case where the execution condition of the NOₓ removal treatment is determined to be satisfied, the main routine proceeds to Step S103 in order to start the NOₓ removal treatment. On the other hand, in a case where the NOₓ removal treatment is not needed in Step S102, in order to execute ordinary fuel injection control without performing the NOₓ removal treatment, the main routine proceeds to Step S110.

In Step S103, the control unit 20 sets conditions regarding the NOₓ removal treatment (initial removal setting is executed). In the first embodiment, as the conditions regarding the NOₓ removal treatment, the processing time (hereinafter referred to as “end time Tend”) until the NOₓ removal treatment is ended, and the total amount of the reducing agent to be supplied to the NOₓ storage-reduction catalyst are set based on the temperature of the NOₓ storage-reduction catalyst 2 and the NOₓ storage amount. End time Tend is set to be longer as the NOₓ storage amount becomes larger and the total amount of the reducing agent is set to be larger as the NOₓ storage amount becomes larger.

In Step S104, the control unit 20 clears a removal timer T. The removal timer T is a timer for recording the time that has elapsed after the NOₓ removal treatment is started. In Step S105, the control unit 20 sets the removal treatment flag Fred. After the preparations for starting the NOₓ removal treatment is made by the above Step S103 to Step S105, the main routine proceeds to Step S106.

In Step S106, the control unit 20 performs setting (injection setting during removal) of the fuel injection for the NOₓ removal treatment. More specifically, the control unit 20 sets the fuel injection timing and the injection amount of the main injection, and the fuel injection timing and the injection amount of the after-injection.

The fuel injection timing and the injection amount of the main injection are set based on, for example, the engine load and the engine speed of the internal combustion engine. The fuel injection timing and the injection amount of the main injection are appropriately set based on known methods.

The injection amount of the after-injection is set to a certain value smaller than the injection amount of the main injection. The fuel injection timing CAaft of the after-injection is set by the fuel injection timing setting control to be described below.

From the injector 14, fuel injection is performed with the fuel injection timing and the injection amount that are set in Step S106. In addition to the main injection, in a case where pilot injection or pre-injection is performed before the main injection, the fuel injection timing and the injection amount of the pilot injection or the pre-injection may be set in Step S106.

In Step S107, the control unit 20 performs addition of the removal timer T by a “cycle ΔT” that is the cycle of the control routine. In Step S108, the control unit 20 determines whether or not the removal timer T indicates end time Tend or greater, which is set in Step S103. In a case where the removal timer T is determined to be equal to or greater end time Tend, the routine proceeds to Step S109 because the NOₓ removal treatment should be ended. On the other hand, in a case where the removal timer T is smaller than end time Tend, the main routine is ended without performing an end procedure of the NOₓ removal treatment because the NOₓ removal treatment should be continued.

In Step S109, the control unit 20 resets the removal treatment flag Fred, and ends the main routine.

When the removal treatment flag Fred is reset in Step S109, in the following control routine, in Step S101, the control unit 20 determines that the NOₓ removal treatment is not being executed, and the routine proceeds to Step S102. In Step S102, when the control unit 20 determines that the execution condition of the NOₓ removal treatment is not satisfied, the main routine proceeds to Step S110. In Step S110, the control unit 20 performs setting regarding normal fuel injection (executes normal fuel injection setting). In the first embodiment, the control unit 20 determines the fuel injection timing and the fuel injection amount by known methods based on, for example, the engine load and the engine speed of the internal combustion engine. Even in the normal fuel injection, a plurality of times of injection may be performed from the injector.

FIG. 16 is a flowchart illustrating a fuel injection timing setting routine for setting the fuel injection timing CAaft of the after-injection. The control of FIG. 16 is executed whenever the routine reaches Step S106 in the control of FIG. 15.

As illustrated in FIG. 16, in Step S111, the control unit 20 acquires the value of the removal timer T. In Step S112, the control unit 20 sets the fuel injection timing CAaft of the after-injection, using, for example, a map showing a relationship between elapsed time and the fuel injection timing of the after-injection, based on the value of the removal timer T acquired in Step S111.

The map showing the relationship between the elapsed time (the value of the removal timer T) and the fuel injection timing of the after-injection is set such that the fuel injection timing CAaft of the after-injection continuously and gradually becomes earlier as time elapses. Particularly, in the first embodiment, the map is created such that the fuel injection timing CAaft of the after-injection reaches 60° ATDC at the time of the start of the NOₓ removal treatment and the fuel injection timing CAaft of the after-injection reaches 20° ATDC at the time of the end of the NOₓ removal treatment, so as to have a relationship illustrated by the solid lines e1 in FIG. 14.

Alternatively, instead of the map, the fuel injection timing CAaft of the after-injection may be calculated based on a calculation formula. In the above-described case (1), for example, the fuel injection timing CAaft of the after-injection is calculated based on the following formula.

CAaft=60−40×(T/Tend) (1)

Here, T is the value of the removal timer T, and Tend is the processing time (end time) until the NOₓ removal treatment is ended.

In the first embodiment, the fuel injection timing CAaft of the after-injection is gradually and continuously changed in accordance with the elapsed time after the NOₓ removal treatment is started. However, the fuel injection timing CAaft of the after-injection may be stepwise changed in accordance with the elapsed time after the NOₓ removal treatment is started. For example, the fuel injection timing CAaft of the after-injection may be set to 60° ATDC during a period from the start of the NOₓ removal treatment to time T1 and may be set to 20° ATDC during a period from time T1 to time Tend. Even when the fuel injection timing CAaft of the after-injection is stepwise fluctuated as described above, a superfluous release of NOₓ in the initial stage of the NOₓ removal treatment is sufficiently suppressed, and the reduction efficiency of NOₓ is further raised in the later stage of the NOₓ removal treatment. Therefore, the NOₓ leak amount can be suppressed to be lower.

As described above, the exhaust gas control apparatus for an internal combustion engine of the first embodiment includes the NOₓ storage-reduction catalyst 2, the injector 14 (reducing agent supplying-and-adjusting device) that is capable of supplying the reducing agent containing hydrocarbon and carbon monoxide to the NOₓ storage-reduction catalyst 2 and adjusting the CO ratio that is the ratio of carbon monoxide to hydrocarbon supplied to the NOₓ storage-reduction catalyst 2, and the control unit 20 (electronic control unit) that controls the injector 14.

When a predetermined removal treatment execution condition is satisfied, the control unit 20 (electronic control unit) controls the injector 14 so as to supply the reducing agent to the NOₓ storage-reduction catalyst 2, and performs the NOₓ removal treatment of removing NOₓ stored in the NOₓ storage-reduction catalyst 2. In the NOₓ removal treatment, the control unit 20 controls the injector 14 such that the CO ratio becomes lower when the NOₓ removal treatment is started than when the NOₓ removal treatment is ended.

According to the exhaust gas control apparatus as described above, the CO ratio when the NOₓ removal treatment is started is relatively low. Therefore, the amount of NOₓ to be released into the exhaust gas from the NOₓ storage material 43 can be maintained to be smaller. As a result of the above, the amount of NOₓ released with respect to the amount of the reducing agent becomes excessive, and the amount of NOₓ leaking downstream of the NOₓ storage-reduction catalyst 2 can be sufficiently decreased. Meanwhile, since the CO ratio when the NOₓ removal treatment is ended is relatively high, the reactivity of the reducing agent with NOₓ released from the NOₓ storage material 43 can be improved, and the NOₓ leak amount can be sufficiently decreased. As described above, in the entire period of time from the start of the NOₓ removal treatment to the end thereof, the NOₓ leak amount can be sufficiently decreased.

There is a case where substantial time is taken until the reducing agent reaches the NOₓ storage-reduction catalyst 2 after the NOₓ removal treatment execution condition is satisfied. In the above-described case, “the CO ratio when the NOₓ removal treatment is started” means the ratio of carbon monoxide to hydrocarbon when the reducing agent is supplied to the NOₓ storage-reduction catalyst 2, due to the reducing agent supplying-and-adjusting device being controlled for the first time, for example, after the NOₓ removal treatment execution condition is satisfied. By controlling the CO ratio determined as described above to be lower, excessive NOₓ release can be further suppressed, and the NOₓ leak amount can be sufficiently decreased.

From a different viewpoint, it is also considered that the CO ratio when the NOₓ removal treatment is started means the CO ratio when a reduction in NOₓ starts in the NOₓ storage-reduction catalyst. Since the CO ratio when a reduction in NOₓ starts contributes to release of NOₓ from the NOₓ storage-reduction catalyst 2, the NOₓ leak amount can be sufficiently decreased by making the CO ratio lower.

Additionally, “the CO ratio when the NOₓ removal treatment is ended” means the ratio of carbon monoxide to hydrocarbon when the reducing agent is supplied to the NOₓ storage-reduction catalyst 2, due to the reducing agent supplying-and-adjusting device being controlled, for example, immediately before the condition for ending the NOₓ removal treatment is satisfied as in Step S108. By controlling the CO ratio determined as described above to be higher, the reactivity of the reducing agent that has reached the NOₓ storage-reduction catalyst 2 after the NOₓ removal treatment is ended can be further raised, and the NOₓ leak amount can be sufficiently decreased.

From a different viewpoint, it is also considered that the CO ratio when the NOₓ removal treatment is ended means the CO ratio when almost all of the stored NOₓ is released in the NOₓ storage-reduction catalyst. By making the CO ratio when almost all of NOₓ stored in is released in the NOₓ storage-reduction catalyst higher, the reactivity of the reducing agent with NOₓ can be further improved, and the NOₓ leak amount can be sufficiently decreased.

Additionally, in the first embodiment, during the NOₓ removal treatment, the injector 14 supplies the reducing agent to the NOₓ storage-reduction catalyst 2 by performing, during one cycle of the internal combustion engine, multi-stage fuel injection including the main injection (first injection) of injecting a largest amount of fuel, and the after-injection (second injection) of injecting a smaller amount of fuel than that in the main injection after the main injection.

The control unit 20 controls the injector 14 in the NOₓ removal treatment such that the fuel injection timing CAaft of the after-injection (the fuel injection timing of the second injection) is delayed when the NOₓ removal treatment is started than when the NOₓ removal treatment is ended.

According to the first embodiment, the CO ratio is adjusted by the injector 14 that is indispensable to the internal combustion engine, there is no need for separately providing a device for adjusting the CO ratio, and the CO ratio is simply adjusted.

The “during the NOₓ removal treatment” is, for example, a period during which the injector 14 performs the after-injection to remove NOₓ in the first embodiment, and is a period until the condition for ending the NOₓ removal treatment is satisfied after the NOₓ removal treatment execution condition is satisfied.

In the first embodiment, the control unit 20 (electronic control unit) adjusts the CO ratio in the NOₓ removal treatment such that the CO ratio increases as time elapses after the NOₓ removal treatment is started.

According to the above configuration, the CO ratio is increased in accordance with to a reduction in the NOₓ storage amount. For the above-described reason, leak of NOₓ can be further appropriately suppressed.

### Second Embodiment

A second embodiment will be described. The second embodiment is different from the first embodiment in that the CO ratio is controlled by recirculating the exhaust gas. In the following, the points that overlap the description of the first embodiment will be omitted.

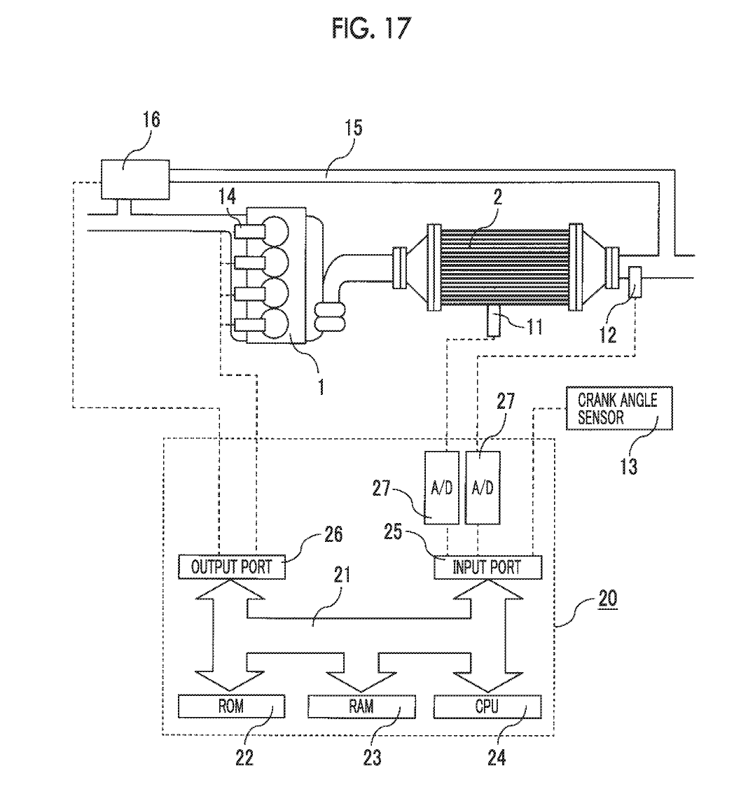

FIG. 17 illustrates a schematic view of an exhaust gas control apparatus in the second embodiment. In addition to the exhaust gas control apparatus in the first embodiment, the exhaust gas control apparatus in the second embodiment includes an exhaust gas recirculation device (EGR device) including an EGR passage 15 and an EGR valve 16. The EGR passage 15 extends between the exhaust passage downstream of the NOₓ storage-reduction catalyst 2 in the exhaust gas flow direction and an intake passage upstream of the engine body 1 in the intake gas flow direction, and allows the exhaust passage and the intake passage to communicate with each other. The EGR valve 16 is disposed in the EGR passage 15 to open and close the EGR passage 15.

The EGR passage 15 is used for introducing a portion of the exhaust gas flowing downstream of the NOₓ storage-reduction catalyst 2 into the upstream of the engine body 1 as EGR gas.

The EGR valve 16 is a valve for adjusting the amount of the exhaust gas supplied from the downstream of the NOₓ storage-reduction catalyst 2 in the exhaust gas flow direction through the EGR passage 15 to the upstream of the engine body 1. In the second embodiment, the EGR valve 16 is an electromagnetic valve, and the opening degree of the EGR valve 16 is controlled in accordance with a signal output from the control unit 20. The EGR valve 16 is controlled such that the EGR rate, which is the ratio of EGR gas to the total intake gas supplied to the combustion chamber, becomes a target EGR rate.

Meanwhile, the oxygen concentration of the exhaust gas flowing downstream of the NOₓ storage-reduction catalyst 2 is low compared to the oxygen concentration of the intake gas supplied from the ambient air. For the above-described reason, when the EGR gas is supplied to the engine body 1 and is combusted as fuel in the engine body 1, CO is easily generated due to insufficient oxygen. Hence, the CO ratio varies in accordance with the EGR rate, and the CO ratio increases as the EGR rate increases.

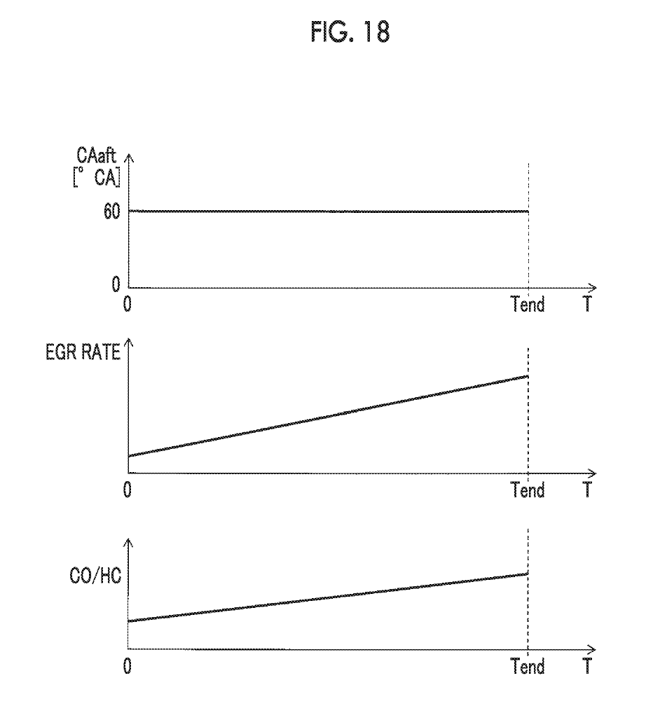

FIG. 18 is a timing chart regarding the NOₓ removal treatment in the second embodiment. FIG. 18 illustrates time changes in the fuel injection timing CAaft of the after-injection, the EGR rate R, and the CO ratio while the NOₓ removal treatment is executed, in order from the upper graph. A horizontal axis represents time, T=0 represents the time when the NOₓ removal treatment is started, and T=Tend represents the time when the NOₓ removal treatment is ended.

In the second embodiment, the fuel injection timing of the after-injection is fixed during the NOₓ removal treatment. By performing the after-injection as described above, the reducing agent is contained in the exhaust gas emitted from the engine body. Meanwhile, in the second embodiment, the EGR control valve is controlled such that the EGR rate R increases as time elapses from the start of the NOₓ removal treatment. As described above, the CO ratio in the reducing agent increases as the EGR rate R increases. Hence, even in the second embodiment, similar to the first embodiment, the CO ratio is increased as time elapses from the start of the NOₓ removal treatment becomes longer. As a result of the above, the leak amount of NOₓ from the NOₓ storage-reduction catalyst 2 during the NOₓ removal treatment can be sufficiently decreased.

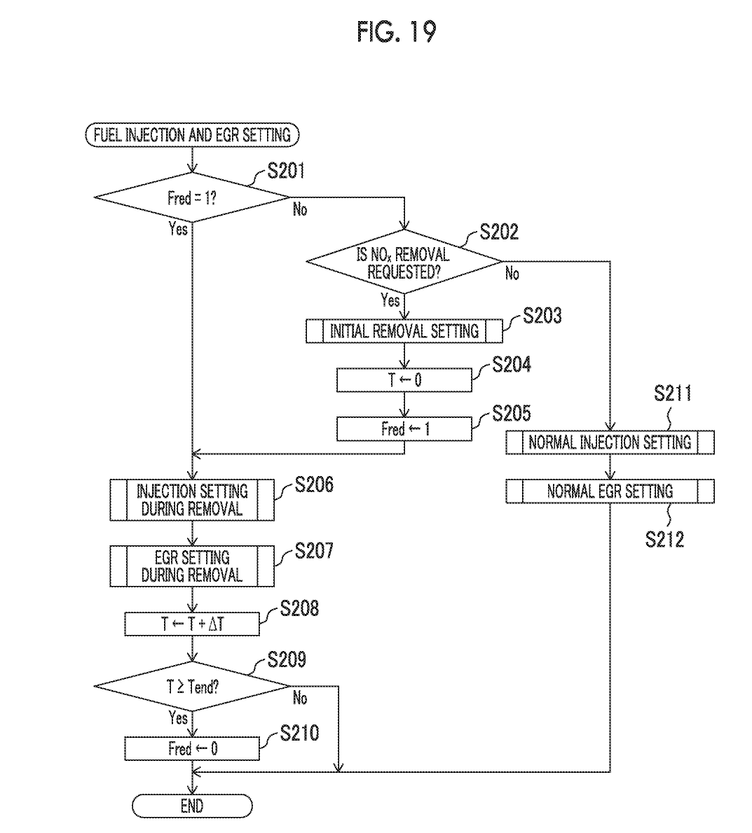

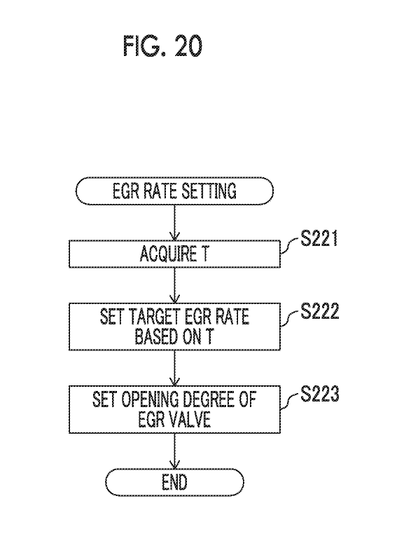

In the following, the control of the NOₓ removal treatment of the second embodiment will be described with reference to FIGS. 19 and 20. FIG. 19 is a flowchart illustrating a control routine of fuel injection and EGR setting in the second embodiment. The illustrated control routine is executed when the crank angle CA measured by the crank angle sensor 13 becomes the predetermined crank angle CA. In addition, since Steps S201 to S205 of FIG. 19 are the same as Steps S101 to S105 of FIG. 15 and Steps S208 to S211 are the same as Steps S107 to S110 of FIG. 15, the description thereof will be omitted.

Referring to FIG. 19, in Step S206, the control unit 20 performs setting (injection setting during removal) of the fuel injection while the NOₓ removal treatment is performed. In the first embodiment, the control unit 20 fluctuates the fuel injection timing CAaft of the after-injection in accordance with the value of the removal timer T. Meanwhile, in the second embodiment, the fuel injection timing CAaft of the after-injection is controlled to a certain value of 60° ATDC.

In Step S207, the control unit 20 sets the opening degree of the EGR valve 16 while the NOₓ removal treatment is performed (the EGR setting during removal is performed). The opening degree of the EGR valve 16 is set based on the EGR rate setting control to be described below.

When the removal treatment flag Fred is determined not to be set in Step S201 and the execution condition of the NOₓ removal treatment is determined not to be satisfied in Step S202, the control routine proceeds to Step S211. In Step S211, the same operation as Step S110 of FIG. 15 is performed. Next, in Step S212, the control unit 20 sets the opening degree (EGR rate R) of the EGR valve 16 during normal control (executes normal EGR setting). In the second embodiment, the control unit 20 sets the opening degree of the EGR valve 16 for the purpose of an improvement in fuel efficiency obtained by reducing the negative pressure of intake gas, knocking reduction, and the like. After Step S204 is executed, the processing of the main routine is ended.

FIG. 20 is a flowchart illustrating an EGR rate setting routine for setting the EGR rate R. The control of FIG. 20 is executed whenever the routine reaches Step S207 in the control of FIG. 19.

In Step S221, the control unit 20 acquires the value of the removal timer T. Next, in Step S222, the control unit 20 sets the target EGR rate, using, for example, a map showing a relationship between the elapsed time and the target EGR rate, based on the value of the removal timer T acquired in Step S221. The map showing the relationship between the elapsed time (the value of the removal timer T) and the target EGR rate is set such that the target EGR rate gradually and continuously increases as time elapses. In the second embodiment, when the removal timer T is 0, the EGR rate R is set such that the EGR rate R reaches 0. When the removal timer T is Tend, the target EGR rate is set such that the CO ratio reaches a predetermined value (for example, 6).

Next, in Step S223, the control unit 20 sets the opening degree of the EGR valve 16 such that an actual EGR rate becomes the target EGR rate calculated in Step S222. When the engine operational state is the same, the opening degree of the EGR valve 16 is set so as to become larger as the target EGR rate increases. For example, when the removal timer T is 0, the control unit 20 sets the opening degree of the EGR valve 16 to 0 such that the EGR rate R reaches 0. As time elapses from the start of the NOₓ removal treatment, the control unit 20 gradually increases the opening degree of the EGR valve 16.

According to the second embodiment, the target EGR rate is set to be relatively low immediately after the start of the NOₓ removal treatment (T=0), and therefore, the CO ratio is made to decline. On the other hand, the target EGR rate is set to be relatively high immediately before the end of the NOₓ removal treatment, and therefore, the CO ratio is increased. As a result of the above, according to the second embodiment, the NOₓ leak amount in the NOₓ removal treatment can also be sufficiently decreased.

In the second embodiment, the EGR rate R is changed with the fuel injection timing CAaft of the after-injection fixed. However, the CO ratio may be changed by changing the fuel injection timing CAaft of the after-injection simultaneously with the change in the EGR rate R.

In the second embodiment, the CO ratio is adjusted by so-called external EGR control that is the control of supplying the exhaust gas to the engine body 1 via the EGR passage 15. As embodiments other than the second embodiment, the exhaust gas may be supplied to the engine body 1 again by opening an exhaust valve at the intake timing of the engine body 1 (internal EGR control). In a case where the internal EGR control is executed by the control unit 20, the CO ratio of exhaust gas may be further raised by further increasing the valve opening time of the exhaust valve or the valve opening stroke of the exhaust valve as the execution time of the NOₓ removal treatment elapses.

As described above, in the second embodiment, the injector 14 that injects fuel to the combustion chamber of the internal combustion engine, and the EGR device (exhaust gas recirculation device) that supplies a portion of the exhaust gas to the combustion chamber again are included as the reducing agent supplying-and-adjusting device capable of supplying the reducing agent containing hydrocarbon and carbon monoxide to the NOₓ storage-reduction catalyst 2 and adjusting the CO ratio that is the ratio of carbon monoxide to the hydrocarbon supplied to the NOₓ storage-reduction catalyst 2. During the NOₓ removal treatment, the injector 14 performs, during one cycle of the internal combustion engine, the multi-stage fuel injection including the main injection (first injection) of injecting a largest amount of fuel, and the after-injection (second injection) of injecting a smaller amount of fuel than that in the main injection after the main injection. According to the above description, the control unit 20 supplies the reducing agent to the NOₓ storage-reduction catalyst 2. The control unit 20 controls the EGR device during the NOₓ removal treatment such that the EGR rate R (exhaust gas circulation rate) that is the ratio of the amount of the exhaust gas supplied to the combustion chamber again to the amount of the intake gas supplied to the combustion chamber becomes lower when the NOₓ removal treatment is started than when the NOₓ removal treatment is ended.

According to the second embodiment, the CO ratio is adjusted by the EGR device that is provided for the internal combustion engine for other applications, there is no need for separately providing a device for adjusting the CO ratio, and the CO ratio is simply adjusted.

The “during the NOₓ removal treatment” is, for example, a period until the condition for ending the NOₓ removal treatment is satisfied after the NOₓ removal treatment execution condition is satisfied, in the second embodiment.

During the NOₓ removal treatment, the control unit 20 (electronic control unit) may set the fuel injection timing CAaft of the after-injection in the first embodiment or may control the EGR device in the second embodiment such that the total amount of hydrocarbon and carbon monoxide is increased as time elapses after the NOₓ removal treatment is started.

According to the above-described configuration, the total amount of hydrocarbon and carbon monoxide, that is, the amount of the reducing agent, is further increased while the CO ratio is further raised as time elapses after the NOₓ removal treatment is started. As the CO ratio is further raised, the released amount of NOₓ from the NOₓ storage-reduction catalyst 2 increases further, and the amount of the reducing agent supplied to the NOₓ storage-reduction catalyst 2 increases further along with an increase in the released amount of the NOₓ. Therefore, time needed in order to reduce NOₓ can be sufficiently shortened.

What is claimed is:

1. An exhaust gas control apparatus for an internal combustion engine, the exhaust gas control apparatus comprising:
a NOₓ storage-reduction catalyst;
a reducing agent supplying-and-adjusting device configured to supply a reducing agent containing hydrocarbon and carbon monoxide to the NOₓ storage-reduction catalyst and adjust a CO ratio that is a ratio of the carbon monoxide to the hydrocarbon supplied to the NOₓ storage-reduction catalyst; and
an electronic control unit configured to control the reducing agent supplying-and-adjusting device, wherein:
when a predetermined removal treatment execution condition is satisfied, the electronic control unit is configured to control the reducing agent supplying-and-adjusting device to supply the reducing agent to the NOₓ storage-reduction catalyst and to perform NOₓ removal treatment in which NOₓ stored in the NOₓ storage-reduction catalyst is removed; and
the electronic control unit is configured to control the reducing agent supplying-and-adjusting device, during the NOₓ removal treatment, such that the CO ratio becomes lower when the NOₓ removal treatment is started than when the NOₓ removal treatment is ended.

2. The exhaust gas control apparatus according to claim 1, wherein:
the reducing agent supplying-and-adjusting device includes an injector that injects fuel into a combustion chamber of the internal combustion engine;
during the NOₓ removal treatment, the injector is configured to perform, during one cycle of the internal combustion engine, multi-stage fuel injection including a first injection of injecting a first amount of fuel, and a second injection of injecting a second amount of fuel which is smaller than the first amount of fuel in the first injection after the first injection to supply the reducing agent to the NOₓ storage-reduction catalyst; and
the electronic control unit is configured to control the injector, during the NOₓ removal treatment, such that a fuel injection timing of the second injection is later when the NOₓ removal treatment is started than when the NOₓ removal treatment is ended.

3. The exhaust gas control apparatus according to claim 2, wherein the electronic control unit is configured to control the injector, during the NOₓ removal treatment, such that the fuel injection timing of the second injection is continuously or stepwise delayed according to an elapsed time after the NOₓ removal treatment is started.

4. The exhaust gas control apparatus according to claim 1, wherein:
the reducing agent supplying-and-adjusting device includes an injector that injects fuel into a combustion chamber of the internal combustion engine, and an exhaust gas recirculation device that supplies a portion of exhaust gas to the combustion chamber;
during the NOₓ removal treatment, the injector is configured to perform, during one cycle of the internal combustion engine, multi-stage fuel injection including a first injection of injecting a first amount of fuel, and a second injection of injecting a second amount of fuel which is smaller than the first amount of fuel in the first injection after the first injection to supply the reducing agent to the NOₓ storage-reduction catalyst; and
the electronic control unit is configured to control the exhaust gas recirculation device such that an exhaust gas circulation rate, which is a ratio of an amount of the exhaust gas supplied to the combustion chamber to an amount of an intake gas supplied to the combustion chamber, becomes lower when the NOₓ removal treatment is started than when the NOₓ removal treatment is ended, during the NOₓ removal treatment.

5. The exhaust gas control apparatus according to claim 4, wherein the electronic control unit is configured to adjust the CO ratio, during the NOₓ removal treatment, such that the CO ratio increases as time elapses after the NOₓ removal treatment is started.

6. The exhaust gas control apparatus according to claim 4, wherein the electronic control unit is configured to adjust the exhaust gas recirculation device during the NOₓ removal treatment such that a total amount of hydrocarbon and carbon monoxide increases as time elapses after the NOₓ removal treatment is started.

7. The exhaust gas control apparatus according to claim 1, wherein the electronic control unit is configured to adjust the CO ratio, during the NOₓ removal treatment, such that the CO ratio increases as time elapses after the NOₓ removal treatment is started.
